(19) United States
(12) Patent Application Publication
(10) Pub. No.: US 2021/0192288 A1
(43) Pub. Date: Jun. 24, 2021

(54) METHOD AND APPARATUS FOR PROCESSING DATA

(71) Applicant: BEIJING BAIDU NETCOM SCIENCE AND TECHNOLOGY CO., LTD., Beijing (CN)

(72) Inventors: Yuhui CAO, Beijing (CN); Shikun FENG, Beijing (CN); Xuyi CHEN, Beijing (CN); Jingzhou HE, Beijing (CN)

(21) Appl. No.: 16/895,242

(22) Filed: Jun. 8, 2020

(30) Foreign Application Priority Data
Dec. 18, 2019 (CN) 201911307167.1

(51) Int. Cl. G06K 9/62; G10L 25/27; G06N 20/00

(52) U.S. Cl. CPC G06K 9/6259; G06N 20/00; G10L 25/27; G06K 9/6298

(57) ABSTRACT

Embodiments of the present disclosure provide a method and apparatus for processing data. The method may include: acquiring a sample set; inputting a plurality of target samples in the sample set into a pre-trained first natural language processing model, respectively, to obtain prediction results output from the pre-trained first natural language processing model; determining the obtained prediction results as labels of the target samples in the plurality of target samples, respectively; and training a to-be-trained second natural language processing model, based on the plurality of target samples and the labels of the target samples to obtain a trained second natural language processing model, parameters in the first natural language processing model being more than parameters in the second natural language processing model.

### CROSS-REFERENCE TO RELATED APPLICATIONS

This application claims priority to Chinese Patent Application No. 201911307167.1, filed on Dec. 18, 2019, titled “Method and apparatus for processing data,” which is hereby incorporated by reference in its entirety.

### TECHNICAL FIELD

Embodiments of the present disclosure relate to the field of computer technology, specifically to the field of Internet technology, and more specifically to a method and apparatus for processing data.

### BACKGROUND

With the development of language processing technology, natural language processing (NLP) models have gradually become widely used. A variety of natural language processing models emerge, some of which have high processing accuracy and large volume.

However, due to the limitation of computing capacity, a natural language processing model having high processing accuracy is not the optimal choice for all computing platforms. Moreover, models having high processing accuracy tend to have slow prediction speed.

### SUMMARY

Embodiments of the present disclosure provide a method and apparatus for processing data.

In a first aspect, an embodiment of the present disclosure provides a method for processing data, the method including: acquiring a sample set, where samples in the sample set are unlabeled sentences; inputting a plurality of target samples in the sample set into a pre-trained first natural language processing model, respectively, to obtain prediction results output from the pre-trained first natural language processing model; determining the obtained prediction results as labels of the target samples in the plurality of target samples, respectively; and training a to-be-trained second natural language processing model, based on the plurality of target samples and the labels of the target samples to obtain a trained second natural language processing model, wherein parameters in the first natural language processing model are more than parameters in the second natural language processing model.

In some embodiments, the label of the target sample is used to indicate a probability that the target sample belongs to any one of at least two types.

In some embodiments, the method further includes: replacing a target word of the sample in the sample set with a specified identifier, where, in the sample containing the specified identifier, a number of the target word accounts for a target ratio or a target number of a number of words in the sample; and adding the sample containing the specified identifier as a new sample of the sample set.

In some embodiments, the method further includes: updating a target word of the sample in the sample set to another word with a same part of speech, where, in the updated sample, a number of the target word accounts for a target ratio or a target number of a number of words in the sample; and adding the updated sample as a new sample of the sample set.

In some embodiments, the method further includes: for the sample of the sample set, intercepting a segment with a target length; and adding the intercepted segment as a new sample of the sample set.

In a second aspect, an embodiment of the present disclosure provide an apparatus for processing data, the apparatus including: an acquisition unit, configured to acquire a sample set, where samples in the sample set are unlabeled sentences; an input unit, configured to input a plurality of target samples in the sample set into a pre-trained first natural language processing model, respectively, to obtain prediction results output from the pre-trained first natural language processing model; a determination unit, configured to determine the obtained prediction results as labels of the target samples in the plurality of target samples, respectively; and a training unit, configured to train a to-be-trained second natural language processing model, based on the plurality of target samples and the labels of the target samples to obtain a trained second natural language processing model, where parameters in the first natural language processing model are more than parameters in the second natural language processing model.

In some embodiments, the label of the target sample is used to indicate a probability that the target sample belongs to any one of at least two types.

In some embodiments, the apparatus is further configured to: replace a target word of the sample of the sample set with a specified identifier, wherein, in the sample containing the specified identifier, a number of the target word accounts for a target ratio or a target number of a number of words in the sample; and add the sample containing the specified identifier as a new sample of the sample set.

In some embodiments, the apparatus is further configured to: update a target word of the sample of the sample set to another word with a same part of speech, wherein, in the updated sample, a number of the target word accounts for a target ratio or a target number of a number of words in the sample; and add the updated sample as a new sample of the sample set.

In some embodiments, the apparatus is further configured to: for the sample of the sample set, intercept a segment of a target length; and add the intercepted segment as a new sample of the sample set.

In a third aspect, an embodiment of the present disclosure provides an electronic device, including: one or more processors; and a storage apparatus, for storing one or more programs, the one or more programs, when executed by the one or more processors, cause the one or processors to implement the method according to any embodiment of the method for processing data.

In a fourth aspect, an embodiment of the present disclosure provides a computer readable storage medium, storing a computer program thereon, the program, when executed by a processor, implements the method according to any embodiment of the method for processing data.

In the data processing solution provided by embodiments of the present disclosure, first, acquiring a sample set, samples in the sample set being unlabeled sentences; then inputting target samples in the sample set into a pre-trained first natural language processing model, to obtain prediction results output from the pre-trained first natural language processing model; next determining the prediction results as labels of the target samples; and finally training a to-be-trained second natural language processing model, based on the target samples and the labels of the target samples to obtain a trained second natural language processing model, parameters in the first natural language processing model being more than parameters in the second natural language processing model. The solution provided by the above embodiments of the present disclosure can use the prediction results of the first natural language processing model as the labels of the samples, and a large number of labeled samples may be obtained to train a small model, thereby a small model having high accuracy and fast running speed is trained.

### BRIEF DESCRIPTION OF THE DRAWINGS

By reading the detailed description of non-limiting embodiments with reference to the following accompanying drawings, other features, objectives and advantages of the present disclosure will become more apparent.

FIG. 1 is a diagram of an example system architecture in which some embodiments of the present disclosure may be implemented;

FIG. 2 is a flowchart of a method for processing data according to an embodiment of the present disclosure;

FIG. 3 is a schematic diagram of an application scenario of the method for processing data according to an embodiment of the present disclosure;

FIG. 4 is a schematic structural diagram of an apparatus for processing data according to an embodiment of the present disclosure; and

FIG. 5 is a schematic structural diagram of a computer system of an electronic device adapted to implement some embodiments of the present disclosure.

### DETAILED DESCRIPTION OF EMBODIMENTS

The present disclosure will be further described below in detail in combination with accompanying drawings and embodiments. It may be appreciated that the specific embodiments described herein are merely used for explaining the relevant disclosure, rather than limiting the disclosure. In addition, it should also be noted that, for the ease of description, only the parts related to the relevant disclosure are shown in the accompanying drawings.

It should be noted that embodiments in the present disclosure and features in the embodiments may be combined with each other on a non-conflict basis. The present disclosure will be described below in detail with reference to the accompanying drawings and in combination with embodiments.

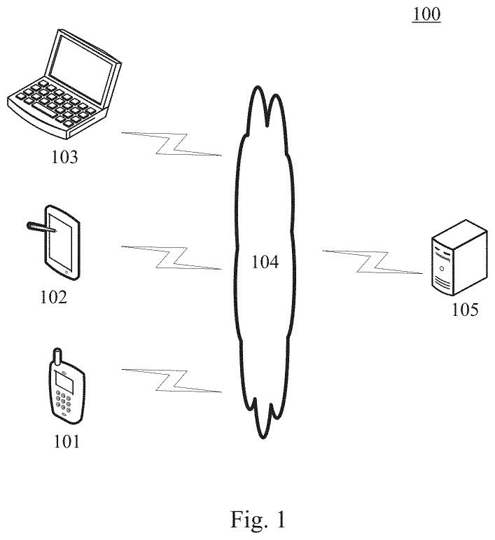

FIG. 1 illustrates an example system architecture 100 in which an embodiment of a method for processing data or an apparatus for processing data of the present disclosure may be implemented.

As shown in FIG. 1, the system architecture 100 may include terminal devices 101, 102, 103, a network 104, and a server 105. The network 104 is used to provide a communication link medium between the terminal devices 101, 102, 103 and the server 105. The network 104 may include various types of connections, such as wired, wireless communication links, or optic fibers.

A user may interact with the server 105 through the network 104 using the terminal devices 101, 102, 103, to receive or send messages and the like. Various communication client applications, such as data processing applications, video applications, live broadcast applications, instant messaging tools, email clients, or social platform software, may be installed on the terminal devices 101, 102, and 103.

The terminal devices 101, 102, and 103 may be hardware or software. When the terminal devices 101, 102, and 103 are hardware, they may be various electronic devices having display screens, including but not limited to smart phones, tablet computers, E-book readers, laptop portable computers, desktop computers, or the like. When the terminal devices 101, 102, and 103 are software, they may be installed in the electronic devices listed above. It may be implemented as a plurality of software or software modules (for example, a plurality of software or software modules for providing distributed services), or as a single software or software module, which is not specifically limited herein.

The server 105 may be a server that provides various services, for example, a backend server that provides support to the terminal devices 101, 102, and 103. The backend server may perform analysis and other processing on data such as a sample set, and feed back a processing result (for example, a trained second natural language processing model) to the terminal devices.

It should be noted that a method for processing data provided by embodiments of the present disclosure may be executed by the server 105 or the terminal devices 101, 102, 103. Correspondingly, the apparatus for processing data may be provided in the server 105 or the terminal devices 101, 102, 103.

It should be understood that the number of terminal devices, networks, and servers in FIG. 1 is merely illustrative. Depending on the implementation needs, there may be any number of terminal devices, networks, and servers.

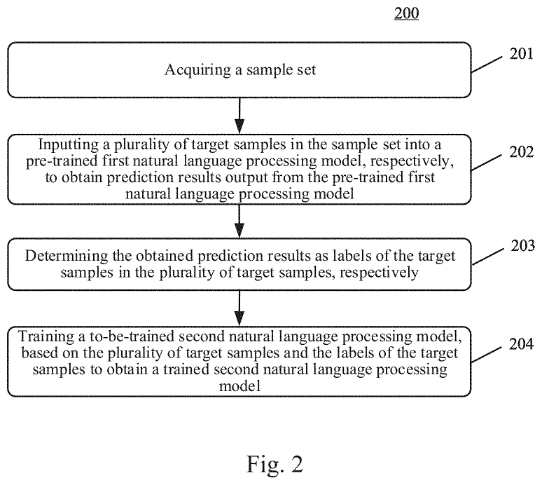

With further reference to FIG. 2, a flow 200 of a method for processing data according to an embodiment of the present disclosure is illustrated. The method for processing data includes the following steps.

Step 201, acquiring a sample set, where samples in the sample set are unlabeled sentences.

In the present embodiment, an executing body of the method for processing data (for example, the server or terminal device shown in FIG. 1) may acquire the sample set. The sample set is composed of samples. There is no label in the samples in the sample set, that is, the samples are unlabeled samples. The sample here may be a sentence itself or a word segmentation result of the sentence.

Step 202, inputting a plurality of target samples in the sample set into a pre-trained first natural language processing model, respectively, to obtain prediction results output from the pre-trained first natural language processing model.

In the present embodiment, for each target sample in the plurality of target samples in the sample set, the executing body may input the target sample into the pre-trained first natural language processing model to obtain the prediction result corresponding to the target sample output from the model. The plurality of target samples here may be all samples in the sample set, or some samples in the sample set.

Specifically, the executing body or other electronic devices may use manually labeled samples to train the first natural language processing model in advance, so as to obtain the pre-trained first natural language processing model.

Step 203, determining the obtained prediction results as labels of the target samples in the plurality of target samples, respectively.

In the present embodiment, the executing body may determine the prediction results of the pre-trained first natural language processing model to the target samples as the labels of the target samples. Specifically, the pre-trained first natural language processing model may be used as a teacher model, and the target sample is labeled through knowledge distillation, that is, prediction of the target sample.

Step 204, training a to-be-trained second natural language processing model, based on the plurality of target samples and the labels of the target samples to obtain a trained second natural language processing model, where parameters in the first natural language processing model are more than parameters in the second natural language processing model.

In the present embodiment, the executing body may train the to-be-trained second natural language processing model based on the target samples and labels of the target samples, to obtain the trained second natural language processing model. Compared with the first natural language processing model, the second natural language processing model is a model with fewer parameters and faster processing speed. The second natural language processing model may be used as a student model of the above teacher model, so as to use the labels generated by the teacher model for training. The executing body may use the trained second natural language processing model for prediction, the prediction speed of which being faster than that of the to-be-trained second natural language processing model, and obtained prediction results are more accurate than the prediction results of the to-be-trained second natural language processing model.

The to-be-trained second natural language processing model here may be an untrained initial second natural language processing model, or may be a pre-trained second natural language processing model.

In practice, the first natural language processing model may be various models, such as an Enhanced Representation from Knowledge Integration (ERNIE) model, or a Bidirectional Encoder Representations from Transformers (BERT) model. The second natural language processing model may be various models, such as a Bag of words (BoW) model or a Bi-directional Long Short-Term Memory (Bi-LSTM) model.

The method provided by the above embodiment of the present disclosure may use the prediction results of the first natural language processing model as the labels of the samples, and a large number of labeled samples may be obtained to train a small model, thereby a small model having high accuracy and fast running speed is trained.

In some alternative implementations of the present embodiment, the label of the target sample is used to indicate a probability that the target sample belongs to any one of at least two types.

In these alternative implementations, the label of the target sample may use the probability that the sample belongs to one type of prediction results in the at least two types as the label of the sample in the sample set, that is, using at least two-dimensional probability distribution (soft-label) as the label.

The labels in these implementations are more accurate than classification results only labeling to which type the samples belong, so that the accuracy and fit of the trained model obtained may be higher.

In some alternative implementations of the present embodiment, the method may further include: replacing a target word of the sample in the sample set with a specified identifier, where, in the sample containing the specified identifier, the number of the target word accounts for a target ratio or a target number of the number of words in the sample; and adding the sample containing the specified identifier as a new sample of the sample set.

In these alternative implementations, the executing body may replace the target word in the words of the sample with the specified identifier. The specified identifier here may hide the replaced word, so that the natural language processing model may use the replaced sample to learn how to use other words to obtain the hidden word, for example, other words may be context words. For example, the specified identifier may be “UNK”.

The target word here may be selected randomly in the sample, or it may be selected according to a specified rule. For each of some or all of the samples, the executing body may use a certain proportion of words in the sample as the target words.

In these implementations, there may be original samples in the sample set, such as samples used for the replacement of the above words, and there may also be new samples obtained after the replacement, so as to expand the sample set. Moreover, through the target ratio and the target number, the number of the new samples may be controlled while expanding the samples. In addition, by the specified identifier, the model's ability to predict the hidden word may be enhanced.

In some alternative implementations of the present embodiment, the method may further include: updating a target word of the sample in the sample set to another word with a same part of speech, where, in the updated sample, the number of the target word accounts for a target ratio or a target number of the number of words in the sample; and adding the updated sample as a new sample of the sample set.

In these alternative implementations, the executing body may update the target word in the sample to obtain a new sample. The target word here may be selected randomly in the sample, or may be selected according to a specified rule. The executing body may randomly select one or select one according to a preset rule, in the words having the same part of speech, and replace the target word.

In these implementations, words having the same part of speech may be used to replace the target word to generate a new sample to perform differentiated expansion of the sample set with high quality.

In some alternative implementations of the present embodiment, the method may further include: for the sample in the sample set, intercepting a segment with a target length,; and adding the intercepted segment as a new sample of the sample set.

In these implementations, the executing body may intercept a part of the existing samples in the sample set as new samples. There may be many different values for the target length. Specifically, the target length may be a random value or may be preset. The location of the interception may be selected randomly or according to a certain rule, such as the first three words of the sample. Typically, the location of the interception may be the location where the word segmentation is performed in the sentence, or a location other than the location where the word segmentation is performed may be used as the location of the interception.

These implementations may increase the richness of the samples by intercepting segments to achieve effective expansion of the samples.

In the sample set, the newly added samples and the original samples before the addition may be mixed in a certain proportion to achieve better training effect.

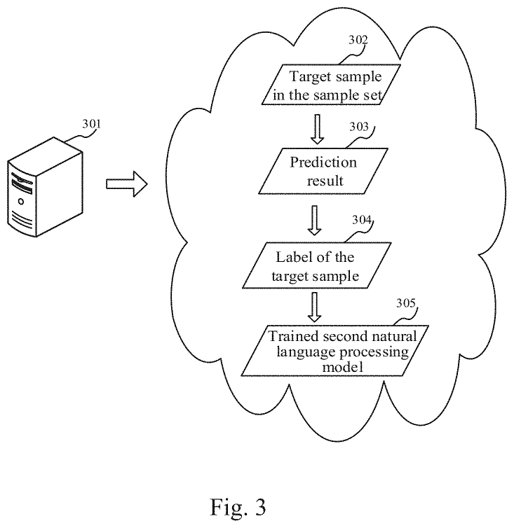

With further reference to FIG. 3, FIG. 3 is a schematic diagram of an application scenario of the method for processing data according to the present embodiment. In the application scenario of FIG. 3, an executing body 301 may acquire a sample set, samples in the sample set being unlabeled sentence segmentation results. The executing body 301 inputs a target sample 302 in the sample set into a pre-trained first natural language processing model to obtain a prediction result 303 output from the pre-trained first natural language processing model. The executing body 301 determines the prediction result as a label 304 of the target sample. The executing body 301 trains a to-be-trained second natural language processing model based on the target sample 302 and the label 304 of the target sample to obtain a trained second natural language processing model 305, where parameters in the first natural language processing model are more than parameters in the second natural language processing model.

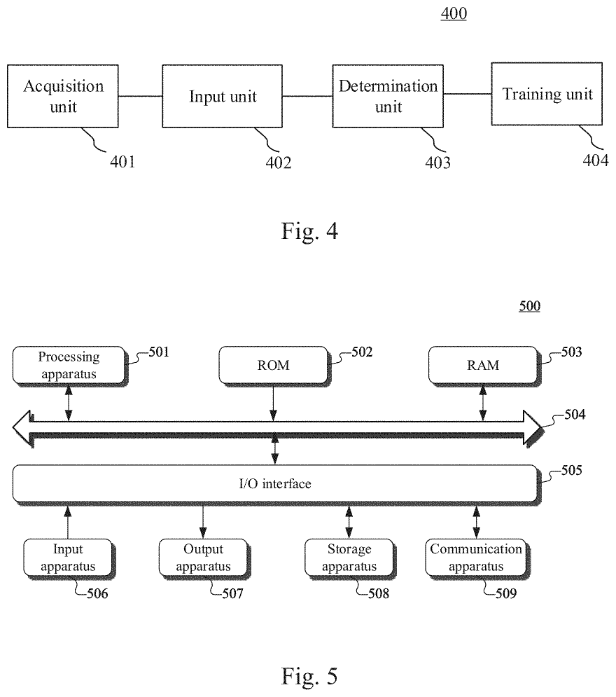

With further reference to FIG. 4, as an implementation of the method shown in the above figures, an embodiment of the present disclosure provides an apparatus for processing data, and the apparatus embodiment corresponds to the method embodiment as shown in FIG. 2. In addition to the features described below, the apparatus embodiment may also include the same or corresponding features or effects as the method embodiment shown in FIG. 2. The apparatus may be specifically applied to various electronic devices.

As shown in FIG. 4, an apparatus 400 for processing data of the present embodiment includes: an acquisition unit 401, an input unit 402, a determination unit 403 and a training unit 404. The acquisition unit 401 is configured to acquire a sample set, samples in the sample set being unlabeled sentences. The input unit 402 is configured to input a plurality of target samples in the sample set into a pre-trained first natural language processing model, respectively, to obtain prediction results output from the pre-trained first natural language processing model. The determination unit 403 is configured to determine the obtained prediction results as labels of the target samples in the plurality of target samples, respectively. The training unit 404 is configured to train a to-be-trained second natural language processing model, based on the plurality of target samples and the labels of the target samples to obtain a trained second natural language processing model, parameters in the first natural language processing model being more than parameters in the second natural language processing model.

In some embodiments, the acquisition unit 401 of the apparatus 400 for processing data may acquire the sample set. The sample set is composed of samples. There is no label in the samples in the sample set, that is, the samples are unlabeled samples. The sample here may be a sentence itself or a word segmentation result of the sentence.

In some embodiment, for each target sample in the plurality of target samples in the sample set, the input unit 402 may input the target sample into the pre-trained first natural language processing model to obtain the prediction result corresponding to the target sample output from the model. The plurality of target samples here may be all samples in the sample set, or some samples in the sample set.

In some embodiments, the determination unit 403 may determine the prediction results of the pre-trained first natural language processing model to the target samples as the labels of the target samples. Specifically, the pre-trained first natural language processing model may be used as a teacher model, and the target sample is labeled through knowledge distillation, that is, prediction of the target sample.

In some embodiments, the training unit 404 may train the to-be-trained second natural language processing model based on the target samples and labels of the target samples, to obtain the trained second natural language processing model. Compared with the first natural language processing model, the second natural language processing model is a model with fewer parameters and faster processing speed.

In some alternative implementations of the present embodiment, the label of the target sample is used to indicate a probability that the target sample belongs to any one of at least two types.

In some alternative implementations of the present embodiment, the apparatus is further configured to: replace a target word of the sample of the sample set with a specified identifier, where, in the sample containing the specified identifier, the number of the target word accounts for a target ratio or a target number of the number of words in the sample; and add the sample containing the specified identifier as a new sample of the sample set.

In some alternative implementations of the present embodiment, the apparatus is further configured to: update a target word of the sample of the sample set to another word with a same part of speech, where, in the updated sample, the number of the target word accounts for a target ratio or a target number of the number of words in the sample; and add the updated sample as a new sample of the sample set.

In some alternative implementations of the present embodiment, the apparatus is further configured to: for the sample of the sample set, intercept a segment of a target length; and add the intercepted segment as a new sample of the sample set.

As shown in FIG. 5, the electronic device 500 may include a processing apparatus (e.g., a central processing unit and a graphics processing unit) 501, which may execute various appropriate actions and processes in accordance with a program stored in a read-only memory (ROM) 502 or a program loaded into a random access memory (RAM) 503 from a storage apparatus 508. The RAM 503 also stores various programs and data required by operations of the electronic device 500. The processing apparatus 501, the ROM 502 and the RAM 503 are connected to each other through a bus 504. An input/output (I/O) interface 505 is also connected to the bus 504.

Generally, the following apparatuses may be connected to the I/O interface 505: an input apparatus 506, including such as a touch screen, a touch pad, a keyboard, a mouse, a camera, a microphone, an accelerometer, or a gyroscope; an output apparatus 507 including such as a liquid crystal display (LCD), a speaker, or a vibrator; the storage apparatus 508 including such as a magnetic tape, or a hard disk; and a communication apparatus 509. The communication apparatus 509 may allow the electronic device 500 to perform wireless or wired communication with other devices to exchange data. Although FIG. 5 shows the electronic device 500 having various apparatuses, it should be understood that it is not required to implement or have all the apparatuses shown. More or fewer apparatuses may be implemented or provided instead. Each block shown in FIG. 5 may represent one apparatus, and may also represent a plurality of apparatuses as required.

In particular, according to embodiments of the present disclosure, the process described above with reference to the flow chart may be implemented in a computer software program. For example, an embodiment of the present disclosure includes a computer program product, which includes a computer program that is tangibly embedded in a machine-readable medium. The computer program includes program codes for executing the method as illustrated in the flow chart. In such an embodiment, the computer program may be downloaded and installed from a network via the communication apparatus 509, or may be installed from the storage apparatus 508, or may be installed from the ROM 502. The computer program, when executed by the processing apparatus 501, implements the functions as defined by the methods of the present disclosure. It should be noted that the computer readable medium in the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination of any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In the present disclosure, the computer readable storage medium may be any tangible medium containing or storing programs which may be used by a command execution system, apparatus or element or incorporated thereto. In the present disclosure, the computer readable signal medium may include data signal in the base band or propagating as parts of a carrier, in which computer readable program codes are carried. The propagating data signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The flow charts and block diagrams in the accompanying drawings illustrate architectures, functions and operations that may be implemented according to the systems, methods and computer program products of various embodiments of the present disclosure. In this regard, each of the blocks in the flow charts or block diagrams may represent a module, a program segment, or a code portion, said module, program segment, or code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The units involved in embodiments of the present disclosure may be implemented by means of software or hardware. The described units may also be provided in a processor, for example, may be described as: a processor including an acquisition unit, an input unit, a determination unit and a training unit. Here, the names of these units do not in some cases constitute limitations to such units themselves. For example the acquisition unit may also be described as “a unit configured to acquire a sample set”.

In another aspect, the present disclosure further provides a computer-readable medium. The computer-readable storage medium may be included in the apparatus in the above described embodiments, or a stand-alone computer-readable medium not assembled into the apparatus. The computer-readable medium stores one or more programs. The one or more programs, when executed by the apparatus, cause the apparatus to: acquire a sample set, where samples in the sample set are unlabeled sentences; input a plurality of target samples in the sample set into a pre-trained first natural language processing model, respectively, to obtain prediction results output from the pre-trained first natural language processing model; determine the obtained prediction results as labels of the target samples in the plurality of target samples, respectively; and train a to-be-trained second natural language processing model, based on the plurality of target samples and the labels of the target samples to obtain a trained second natural language processing model, where parameters in the first natural language processing model are more than parameters in the second natural language processing model.

The above description provides an explanation of certain embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present disclosure are examples.

What is claimed is:

1. A method for processing data, the method comprising:
acquiring a sample set, wherein samples in the sample set are unlabeled sentences;
inputting a plurality of target samples in the sample set into a pre-trained first natural language processing model, respectively, to obtain prediction results output from the pre-trained first natural language processing model;
determining the obtained prediction results as labels of the target samples in the plurality of target samples, respectively; and
training a to-be-trained second natural language processing model, based on the plurality of target samples and the labels of the target samples to obtain a trained second natural language processing model, wherein parameters in the first natural language processing model are more than parameters in the second natural language processing model.

2. The method according to claim 1, wherein the label of the target sample is used to indicate a probability that the target sample belongs to any one of at least two types.

3. The method according to claim 1, wherein the method further comprises:
replacing a target word of the sample in the sample set with a specified identifier, wherein, in the sample containing the specified identifier, a number of target word accounts for a target ratio or a target number of a number of words in the sample; and
adding the sample containing the specified identifier as a new sample of the sample set.

4. The method according to claim 1, wherein the method further comprises:
updating a target word of the sample in the sample set to another word with a same part of speech, wherein, in the updated sample, a number of target word accounts for a target ratio or a target number of a number of words in the sample; and
adding the updated sample as a new sample of the sample set.

5. The method according to claim 1, wherein the method further comprises:
for the sample of the sample set, intercepting a segment with a target length; and
adding the intercepted segment as a new sample of the sample set.

6. An apparatus for processing data, the apparatus comprising:
at least one processor; and
a memory storing instructions, wherein the instructions when executed by the at least one processor, cause the at least one processor to perform operations, the operations comprising:
acquiring a sample set, wherein samples in the sample set are unlabeled sentences;
inputting a plurality of target samples in the sample set into a pre-trained first natural language processing model, respectively, to obtain prediction results output from the pre-trained first natural language processing model;
determining the obtained prediction results as labels of the target samples in the plurality of target samples, respectively; and
training a to-be-trained second natural language processing model, based on the plurality of target samples and the labels of the target samples to obtain a trained second natural language processing model, wherein parameters in the first natural language processing model are more than parameters in the second natural language processing model.

7. The apparatus according to claim 6, wherein the label of the target sample is used to indicate a probability that the target sample belongs to any one of at least two types.

8. The apparatus according to claim 6, wherein the operations further comprise:
replacing a target word of the sample of the sample set with a specified identifier, wherein, in the sample containing the specified identifier, a number of target word accounts for a target ratio or a target number of a number of words in the sample; and
adding the sample containing the specified identifier as a new sample of the sample set.

9. The apparatus according to claim 6, wherein the operations further comprise:
updating a target word of the sample of the sample set to another word with a same part of speech, wherein, in the updated sample, a number of target word accounts for a target ratio or a target number of a number of words in the sample; and
adding the updated sample as a new sample of the sample set.

10. The apparatus according to claim 6, wherein the operations further comprise:
for the sample of the sample set, intercepting a segment of a target length; and
adding the intercepted segment as a new sample of the sample set.

11. A non-transitory computer readable storage medium, storing a computer program thereon, the program, when executed by a processor, causes the processor to perform operations, the operations comprising:
acquiring a sample set, wherein samples in the sample set are unlabeled sentences;
inputting a plurality of target samples in the sample set into a pre-trained first natural language processing model, respectively, to obtain prediction results output from the pre-trained first natural language processing model;
determining the obtained prediction results as labels of the target samples in the plurality of target samples, respectively; and
training a to-be-trained second natural language processing model, based on the plurality of target samples and the labels of the target samples to obtain a trained second natural language processing model, wherein parameters in the first natural language processing model are more than parameters in the second natural language processing model.

12. The non-transitory computer readable storage medium according to claim 11, wherein the label of the target sample is used to indicate a probability that the target sample belongs to any one of at least two types.

13. The non-transitory computer readable storage medium according to claim 11, wherein the operations further comprise:
replacing a target word of the sample of the sample set with a specified identifier, wherein, in the sample containing the specified identifier, a number of target word accounts for a target ratio or a target number of a number of words in the sample; and
adding the sample containing the specified identifier as a new sample of the sample set.

14. The non-transitory computer readable storage medium according to claim 11, wherein the operations further comprise:
updating a target word of the sample of the sample set to another word with a same part of speech, wherein, in the updated sample, a number of target word accounts for a target ratio or a target number of a number of words in the sample; and
adding the updated sample as a new sample of the sample set.

15. The non-transitory computer readable storage medium according to claim 11, wherein the operations further comprise:
for the sample of the sample set, intercepting a segment of a target length; and
adding the intercepted segment as a new sample of the sample set.
